(19) United States
(12) Patent Application Publication
(10) Pub. No.: US 2018/0204076 A1
(43) Pub. Date: Jul. 19, 2018

(54) MOVING OBJECT DETECTION AND CLASSIFICATION IMAGE ANALYSIS METHODS AND SYSTEMS

(71) Applicants: The Regents of the University of California, Oakland, CA (US); Korea Electronics Technology Institute, Seongnam-si (KR)

(72) Inventors: Subarna Tripathi, San Diego, CA (US); Kunyao Chen, San Diego, CA (US); Truong Nguyen, San Diego, CA (US); Youngbae Hwang, Seongnam-si (KR)

(21) Appl. No.: 15/872,378

(22) Filed: Jan. 16, 2018

Related U.S. Application Data
(60) Provisional application No. 62/446,152, filed on Jan. 13, 2017.

(51) Int. Cl. G06K 9/00; G06T 7/246; G06K 9/62; B60Q 9/00; G05D 1/02

(52) U.S. Cl. CPC G06K 9/00805; G06T 7/248; G06K 9/6269; G06K 9/6256; G05D 1/0088; G05D 1/0246; G06T 2210/12; G06T 2207/10024; G06T 2207/30261; B60Q 9/00

(57) ABSTRACT

A method for moving objection detection in an image analysis system is provided. The method includes analyzing consecutive video frames from a single camera to extract box properties and exclude objects that are not of interest based upon the box properties. Motion and structure data are obtained for boxes not excluded. The motion and structure data are sent to a trained classifier. Moving object boxes are determined by the trained classifier. The moving object box identifications are provided to a vehicle system. The data sent to the classifier can consist of the motion and structure data, and no deep learning methods are applied to the video frame data. Driver assistance vehicle systems and autonomous driving systems are also provided based upon the moving object box detection.

### PRIORITY CLAIM AND REFERENCE TO RELATED APPLICATION

The application claims priority under 35 U.S.C. §119 and all applicable statutes and treaties from prior U.S. provisional application Ser. No. 62/446,152, which was filed Jan. 13, 2017.

### FIELD

Fields of the invention include image analysis, vision systems, moving object detection, driving assistance systems and self-driving systems.

### BACKGROUND

Image analysis systems that can detect moving objects can be applied in various environments, such as vehicle assistance systems, vehicle guidance systems, targeting systems and many others. Moving object detection is especially challenging when the image acquisition device(s), e.g. a camera, is non-stationary. This is the case for driver assistance systems on vehicles. One or more cameras are mounted on a vehicle to provide a video feed to an analysis system. The analysis system must analyze the video feed and detect threat objects from the feed. Static objects have relative movement with respect to a moving vehicle, which complicates the detection of other objects that have relative movement with respect to the static surrounding environment.

Moving object detection can play an important role in driver assistance systems. Detecting an object moving towards a vehicle can alert a drive and/or trigger a vehicle safety system such as automatic braking assistance and avoid the collisions when the drivers are distracted. This is an area of active research. Many recent efforts focus on specific objects, such as pedestrians. See, R. Benenson, M. Omran, J. Hosang, and B. Schiele, “Ten years of pedestrian detection, what have we learned?” in European Conference on Computer Vision. Springer, 2014, pp. 613-627. Such specific object systems are limited to the objects that they have been designed to detect, and can fail to provide assistance in common driving environments, e.g. expressway driving.

Semantic segmentation concerns techniques that enable identification of multiple moving objects and types of objects in one frame, e.g., vehicles, cyclists, pedestrian etc. Many semantic segmentation methods are too complicated to work in real time with modern vehicle computing power. See, L.-C. Chen, G. Papandreou, I. Kokkinos, K. Murphy, and A. L. Yuille, “Semantic image segmentation with deep convolutional nets and fully connected CRFs,” arXiv:1412.7062v4, 2014; J. Long, E. Shelhamer, and T. Darrell, “Fully convolutional networks for semantic segmentation,” in Proceedings of the IEEE Conference on Computer Vision and Pattern Recognition, 2015, pp. 3431-3440. Real time approaches frequently suffer from significant noise and error. Shotton, M. Johnson, and R. Cipolla, “Semantic texton forests for image categorization and segmentation,” in Computer vision and pattern recognition, 2008. CVPR 2008. IEEE Conference on. IEEE, 2008, pp. 1-8. Another problem inherent to segmentation methods is that such methods only identify or display objects. Without motion information, the systems cannot detect if object is moving, which is highly valuable information to trigger driver warning systems or automatic vehicle systems.

Zhun Zhong et al recently proposed methods that re-rank object proposals to include moving vehicles on KITTI dataset. Z. Zhong, M. Lei, S. Li, and J. Fan, “Re-ranking object proposals for object detection in automatic driving,” CoRR, vol. abs/1605.05904, 2016. This proposed approach uses many complex features such as semantic segmentation results, CNN (convolutional neural network) features, and stereo information. The complexity is not amenable for hardware-implementation with modern on-vehicle systems. Even with sufficient computing power, the approach is likely to perform poorly in sparsely annotated datasets such as CamVid. See, G. J. Brostow, J. Fauqueur, R. Cipolla, “Semantic object classes in video: A high-definition ground truth database,” Pattern Recognition Letters 30(2): 88-97, 2009.

### SUMMARY OF THE INVENTION

Embodiments of the invention include a method for moving objection detection in an image analysis system. The method analyzes consecutive video frames from a single camera to extract box properties and exclude objects that are not of interest based upon the box properties. Motion and structure data is obtained for boxes not excluded. The motion and structure data is sent to a trained classifier. Moving object boxes are identified by the trained classifier. The moving object box identification is provided to a vehicle system. The data sent to the classifier preferably consists of the motion and structure data. The structure data can include box coordinates, normalized height, width and box area, and a histogram of color space components. The motion data can include a histogram of direction data for each box of the boxes not excluded and a plurality of neighboring patches for each box. The box properties can include bottom y and center x coordinate, normalized height, width and box area, and aspect ratio. Boxes can be excluded, for example, when the boxes are less than a predetermined size or adjacent a frame boundary. The motion data preferably includes magnitude and direction of the motion for each pixel in boxes and for neighboring patches and the classifier determines moving object boxes based upon differences.

A preferred driver assistance system on a motor vehicle includes at least one camera providing video frames of scenes external to the vehicle. The video frames are provided to an image analysis processor, and the processor executes the method of the previous paragraph. The result of the analysis is used to trigger an alarm, a warning, a display or other indication to an operator of the vehicle, or to trigger a vehicle safety system, such as automatic braking, speed control, or steering control, or to a vehicle autonomous driving control system.

A preferred motor vehicle system includes at least one camera providing video frames of scenes external to the vehicle. An image analysis system receives consecutive video frames from the at least one camera. The image analysis system analyzes consecutive video frames from a single camera of the at least one camera to extract box properties and exclude objects that are not of interest based upon the box properties, obtains motion and structure data for boxes not excluded and sends the motion and structure data to a trained classifier. The classifier identifies moving object boxes. The data sent to the classifier consists of the motion and structure data. A driving assistance or autonomous driving system includes an object identification system and receives and responds to moving object boxes detected by the trained classifier.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a preferred embodiment method for moving objection detection in an image analysis system;

FIG. 2 illustrates box properties utilized by a preferred embodiment method for moving objection detection in an image analysis system;

FIGS. 3A and 3B illustrate boxes and neighbor patches analyzed by a preferred embodiment method for moving objection detection in an image analysis system; and

FIGS. 4A and 4B are (color) images illustrating training and operation of a preferred embodiment driver assistance system on a motor vehicle.

### DETAILED DESCRIPTION OF THE PREFERRED EMBODIMENTS

Preferred embodiments of the invention include moving object detection methods and systems that provide a hardware friendly framework for moving object detection. Instead of using complex features, preferred methods and systems identify a predetermined feature set to achieve successful detection of different types of moving objects. Preferred methods train a classifier, but avoid the need for deep learning. The classifier needs only pre-selected box and motion properties to determine objects of interest. Compared to deep learning methods, a system of the invention can therefore perform detection more quickly and with less computing power than systems and methods that leverage deep learning.

A preferred system of an invention is a vehicle, such as an automobile. The vehicle includes one or more cameras. The one or more cameras provide image data to an image analysis system. The image analysis system analyzes the image data in real time separately for each of the one or more cameras, and analyzes consecutive video frames from a camera. The image analysis system provides critical data to a driving assistance or autonomous driving system, which can include acceleration, braking, steering, and warning systems. Example autonomous driving systems that can be utilized in a vehicle system of the invention are described, for example, in U.S. Pat. No. 8,260,482 assigned to Google, Inc. and Waymo, LLC, which is incorporated by reference herein. A specific preferred embodiment of the invention replaces the object detection component of the '482 patent with an image analysis system of the present invention that detects objects, or modifies the objection detection component with a method for moving object detection of the invention.

Those knowledgeable in the art will appreciate that embodiments of the present invention lend themselves well to practice in the form of computer program products. Accordingly, it will be appreciated that embodiments of the present invention may comprise computer program products comprising computer executable instructions stored on a non-transitory computer readable medium that, when executed, cause a computer to undertake methods according to the present invention, or a computer configured to carry out such methods. The executable instructions may comprise computer program language instructions that have been compiled into a machine-readable format. The non-transitory computer-readable medium may comprise, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

Preferred embodiments of the invention will now be discussed with respect to drawings and experiments. The drawings and experiments will be understood by artisans in view of the general knowledge in the art and the description that follows to demonstrate broader aspects of the invention.

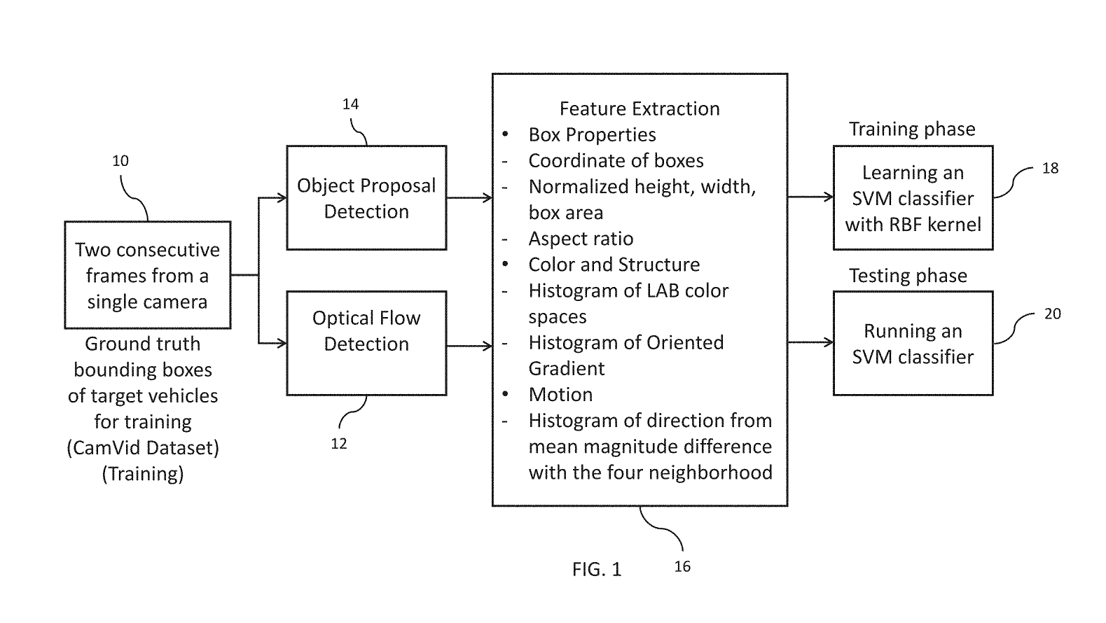

A preferred method for moving objection detection in an image analysis system is provided and illustrated in FIG. 1. FIG. 1 illustrates both a training phase and a testing (operational) phase. The method receives at least two consecutive video frames from a single camera in step 10. In the training phase, at least one of the frames in step 10 includes ground truth bounding boxes to bound vehicles (and/or other moving objects). The ground truth boxes can be assigned by humans, for example, reviewing training frames. The preferred method is based on optical flow conducted in step 12, which is a pixel-wise motion field between two consecutive frames. Optical flow detection in step 12 computes the optical flow of pixels in the consecutive frames being evaluated throughout the frames. Preferably, the flow is determined for all pixels in the frame. Sampling, such as alternating pixels row-wise or via other sampling techniques that allow interpolation or estimation of motion throughout the frame, can be alternatively applied. Motion flow in step 12 requires consecutive frames from a single camera. A typical frame rate of 30 frames per second is suitable as an example. The object proposal detection step 14 detects boxes (that include objects). The consecutive frames are then analyzed in step 16 to extract box properties (preferably including coordinates of boxes, normalized height, width, and box areas, aspect ratio of boxes) and immediately exclude objects in a frame that are not of interest based upon the box properties. Color and structure properties of boxes not excluded are analyzed. The color and structure information are extracted with box properties and motion information for a candidate box. The boxes not excluded are analyzed further to distinguish boxes of objects that are associated with potential objects on the ground from other boxes of objects. Motion is analyzed for boxes and neighbor patches to determine objects meriting an alert.

Particular preferred methods and systems use a set of three features: 1) box properties; 2) color and structure properties; and 3) motion properties. In a preferred embodiment, color information of typical road surfaces is leveraged by extracting LAB histogram of bottom patches of the target object. In the preferred embodiment, the three features are used for training an SVM (support vector machine) classifier (step 18). Then, for each input box, the system can detect a moving object by applying the trained SVM classifier (step 20). In a training phase (step 18), the classifier learns. In a testing (operational) phase (step 20), the trained classifier can, for example, utilize the properties of potential boxes to detect moving objects, usually vehicles.

As an example process, for boxes identified with objects (Step 12), step 16 computes the features of these boxes (bottom y and center x coordinate, normalized height, width and box area, as well as aspect ratio). Boxes that are too small or near the edge of the frame, for example, are excluded from further consideration leaving a group of candidate boxes for motion analysis. Information for the motion analysis is provided via step 12 that performs optical flow (compute magnitude and motion of each pixel). With the intuition that moving objects in candidate boxes should have different motion patterns with their surrounding area, the process in step 16 considers four neighboring patches of the candidate box with an object. In a preferred implementation, the mean magnitude difference with the four neighbors is calculated, then the direction histogram (e.g., 20 bins each) of the four neighbor patches and the candidate box are collected as the final motion features to provide when the SVM classifier is run in step 20.

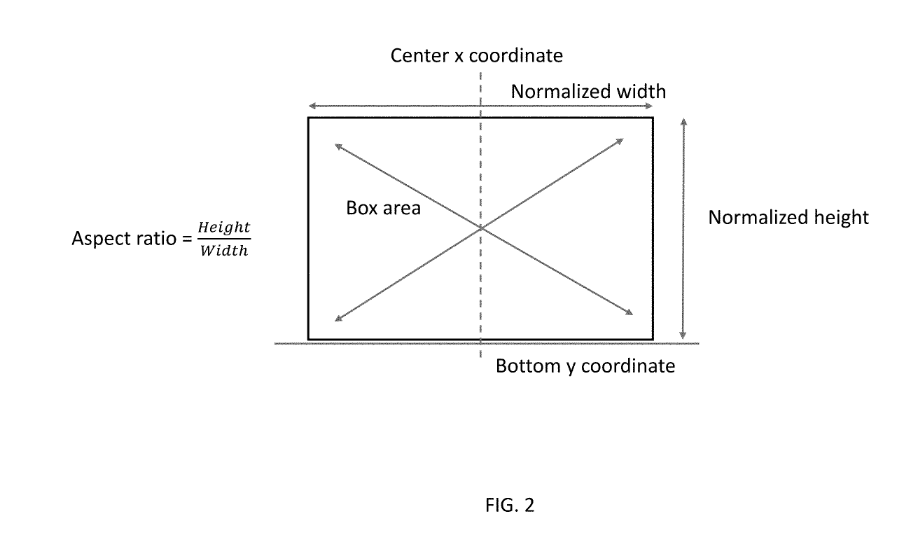

In preferred methods and systems, extracting box properties includes extracting the features purely related to the box itself, which include bottom y and center x coordinate, normalized height, width and box area, as well as aspect ratio. This is illustrated in FIG. 2. The box properties can be used to extract objects that are too distant to merit attention. For example, the system can classify boxes related to object under a predetermined size as being too distant to merit attention. Similarly, boxes of objects running in lanes close to the boundaries of a video frame, and those running far ahead can be classified as not meriting attention. The box property analysis can therefore exclude many objects in a given scene of a video frame. This simplifies subsequent analysis. For the usual camera attached in the vehicle, the scenes will be similar For example, road surfaces are at the bottom, and the sky is above. A close car has a large box, and a distant car has a small box. It is less probable that distant car has a large box. Because training used a ground truth of bounding boxes for vehicles in the road, those box properties can be used to detect more probable boxes.

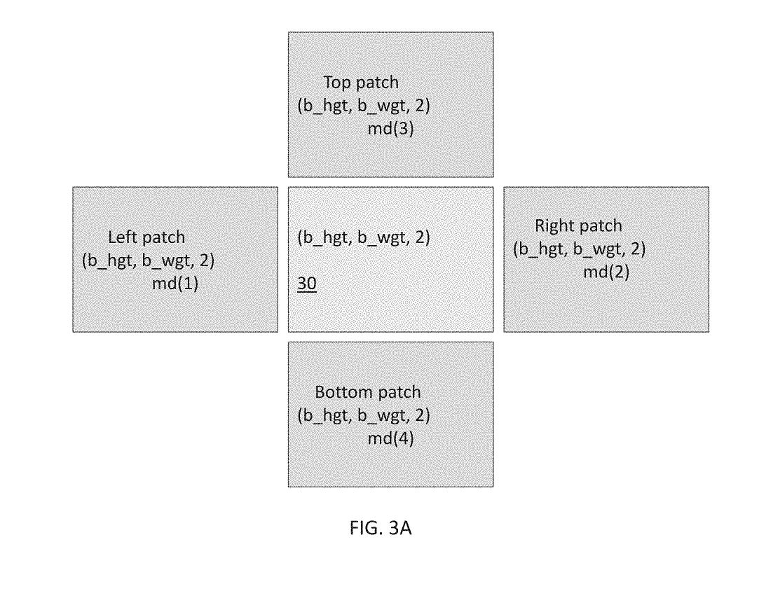

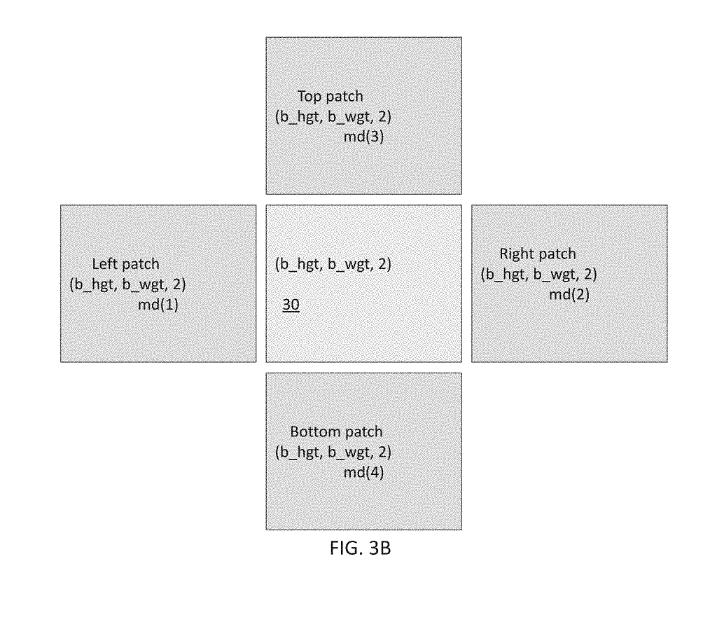

An example is shown in FIGS. 3A and 3B. In FIGS. 3A and 3B, “b_hgt” is box height, “b_wgt” is box width, and 2 indicates the number of optical flow channels, which are two channels of u(horizontal) and v(vertical) in the example. The patches are sized according to the box, for example the patches have the same dimensions as the candidate box. As an alternative, the patches can have a size that matches the side of a box and extends a percentage of the other dimension away. As another alternative, the patches can be some percentage of the box, e.g., 90-95% of the box. The patches could also have different shape than the box, e.g., a triangular shape with the base matching or approximating a side of the box. For a given candidate box then, these patches are unique to the candidate box, as the patches are sized according to the candidate box and are neighbors of the candidate box. Some of the neighboring patches can have different sizes also, such as when one of the patches extends to the boundary of a frame. FIGS. 3A shows a candidate box 30 and four same-sized neighbor patches and (1-4) that are immediately adjacent the candidate box 30. Step 16 then determines a normalized LAB histogram of center box 20—bins representation of L (0:100), A&B (−128:127) HOG of central box, then takes a first N, e.g. N=50 principle components. A normalized LAB histogram of bottom patch md(4) can reveal a classifier Intuition: objects of interest are always on the road. In FIG. 3B, the classifier loads magnitudes and angles from optical flow color map, mean magnitude difference with 4 neighbor patches to the candidate box, and an angle histogram of all the candidate box and the 4 neighbor patches (20 bins each).

Having excluded objects by applying box properties, the color and feature analysis then analyzes objects of non-excluded boxes. The preferred example method considers color and structure information inside the boxes being analyzed. For the color feature, create a LAB histogram (CIELAB color space; other color spaces can be used) such as 20 (or another number N) bins representation for each L, A, B component, where N determines the number of discrete values for each color component. HOG (Histogram of Oriented Gradients) features are utilized for the structure information. For each pixel in the box, the histogram of oriented gradients (edge direction) is determined. See, Dalal and Triggs, “Histograms of oriented gradients for human detection,” CVPR'05. After PCA (principal component analysis), a particularly preferred method keeps a limited predetermined number of components (dominant eigenvectors to express the data), e.g., less than 100 or more preferably only 50 components without sacrificing significant accuracy. The preferred method also extracts an LAB histogram for the bottom patches (with same size of the candidate box—a bottom patch is defined as a box that has the same size as the candidate box and is directly under and adjacent to the candidate box). This operation recognizes that objects of interest are on the ground, instead of being elevated therefrom.

For the motion analysis, after applying the real-time optical flow, the method can obtain magnitude and direction of the motion for each pixel. Real-time optical flow is preferably conducted with the method of T. Brox and J. Malik, “Large displacement optical flow: Descriptor matching in variational motion estimation,” PAMI, 2011. With the intuition that moving objects should have different motion pattern with its surrounding, the preferred method considers four neighboring patches of the predetermined box that are the same size of the predetermined box. First, calculate the mean magnitude difference with the four neighbors, then combine the direction histogram (N, e.g. 20 bins each) of all five patches as the final motion features. The preferred method divides 360 degrees into N=20 bins. For each pixel, the direction(angle) of the motion is computed.

Then, classification can be conducted. In preferred methods, an SVM (Support Vector machine) is used for classification, and a CamVid dataset (The Cambridge—driving Labeled Video Database) is used as a training set. Other classifiers can be used, for example. Adaboost, MLP (Multi-Layer Perceptron), and regression classifiers. Ground truth bounding boxes for the target objects (vehicles) are needed and are provided during a training phase. In a training set, features extracted from those ground truth boxes are taken as positive samples. For the negative sample, the method first applies hard negative mining The method generates candidate windows with decreasing scores using a windowing method such as EdgeBoxes. See, P. Dollar and C. L. Zitnick, “Edge boxes: Locating object proposals from edges,” ECCV, 2014. Only the windows which have less than 30% IOU (intersection over union) with any ground truth are considered as negative samples. As with R-CNN [R. Girshick, J. Donahue, T. Darrell, and J. Malik, “Rich feature hierarchies for accurate object detection and semantic segmentation,” CVPR, 2014], the method also sets negative to positive sample ratio around 3:1. Then, the method learns an SVM classifier with RBF (radial basis fundction) kernel. Other windowing methods include selective search, objectness, etc. The present invention is not a deep learning method like Girschick, et al. The preferred method merely uses the ratio of negative to positive samples from that technique.

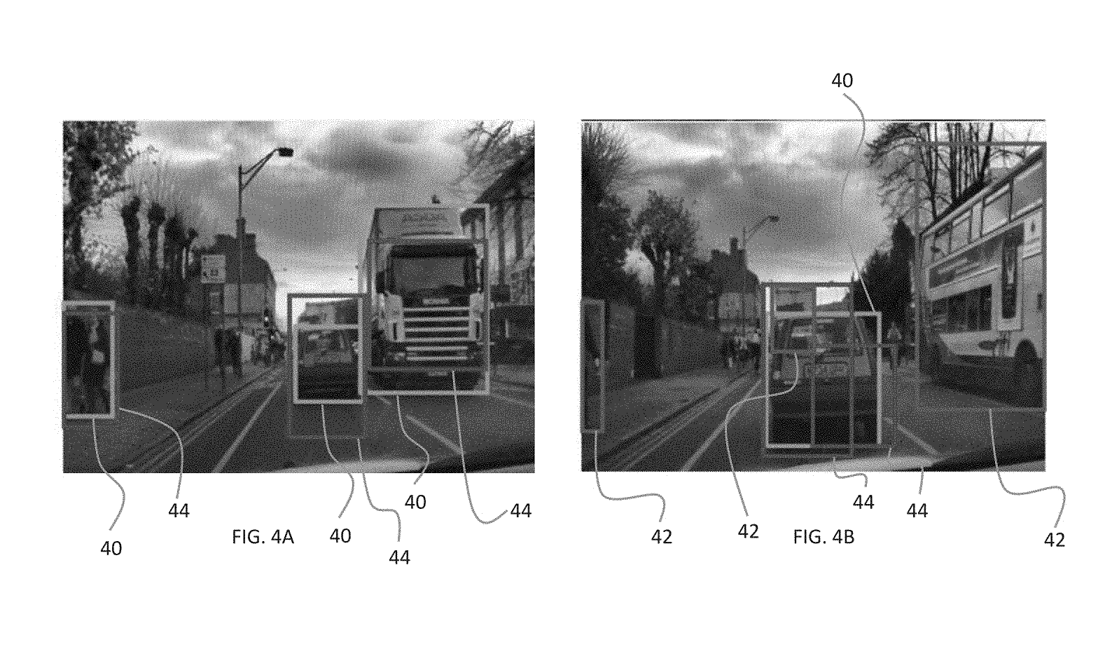

The preferred method was simulated in experiments, repeating the same box and positive and negative sample generation process in the test set. As we cannot control the number of negative sample in this step, the negative to positive sample ratio can reach 7:1. With the features we design, the overall classification accuracy is 81.4%. As EdgeBoxes still generates many overlapped boxes, non-maximum-suppression (NMS) is applied to remove those overlapped boxes and only keep the boxes with largest area in one region. After non-maximum suppression, remaining boxes with more than 50% IOU are taken as true detections. In this criterion, we can achieve 66.2% detection rate. FIGS. 4A and 4B show two frame results. FIG. 4A shows that the method successfully detects different objects in the single framework, with varied objects being detected. The experiments merely took the results of semantic segmentation as ground truths, and therefore some missing detections are purposefully neglected or ignored, e.g. small moving objects classified to be smaller than a potential object of interest. FIG. 4B shows that a truck running far ahead does not have any influence on driving and need not be analyzed in a present frame or used by any driving system in response to the current frame. In FIGS. 4A and 4B, a number of ground truth boxes 40 (green) are indicated that identify moving objects in a training phase, for example true values manually defined by humans in a training set. Excluded candidate boxes 42 (red) define boxes that are too small on the ground position, not on the ground or lack movement on the ground position. Objects that are too large or have incorrect aspect ratios can also be excluded, e.g., the bus on the right edge of the frame in FIG. 4B (too large) or the pedestrian on the left edge of the frame (too large of a vertical to horizontal aspect ratio). Moving object boxes 44 (blue) are detected by box properties and motion information via the classifier as discussed above. In this sense, the framework applies more intelligence in practice and the detection rate of the present method is higher than first observed, in practical terms, because objects analyzed by other types of systems are initially excluded in the present method and not analyzed. The system can detect moving objects by using the cue of box properties, color and structure information, and motion information, while providing only a small amount of information to the classifier instead of providing, for example, complete scene image information for analysis by a deep learning algorithm.

With regard to FIGS. 1-4B, an example set of information generated for the SVM classifier of FIG. 1 in both the training step 18 and the operational/testing step 20 is now discussed. In both of the training and operation, the classifier receives candidate box features and motion information for the candidate box and neighboring patches. During training ground truth boxes are provided. In a preferred embodiment, the information sent to the classifier includes 1) normalized histogram of the candidate box (e.g., 20 bins); 2) normalized histogram of the bottom patch (e.g., 20 bins); 3) principal components of the HOG of the candidate box (e.g., 50 principal components); 4) magnitude and angles of optical flow for the candidate box and the neighboring patches; 5) mean magnitude difference of the neighboring patches; and 6) and angle histogram of the candidate box and the neighboring patches (e.g., 20 bins each). The classifier can be training to determine moving object boxes using box features such as the bottom y coordinate (or stereo information, if available, as when a vehicle system has multiple cameras and provides stereo information), center x coordinate, normalized height, width and area, aspect ratio, object features such as color and structure (e.g., edges, contrast), and motion features (such as relative motion to surrounding patches). For example, for the motion feature, the classifier can load magnitudes from the optical flow color map, the mean magnitude different of a candidate box with neighbor patches and an angle histogram of the candidate box and its neighbor patches.

The experimental results showed a satisfactory detection rate even with simple SVM (support vector machine) classifier and the example set of features. Other classifiers can be used, for example, Adaboost, MLP (Multi-Layer Perceptron), regression. Preferred embodiments avoid deep learning techniques, and the required computing power. The preferred embodiments can enable or enhance a broad range of applications for driver assistance system, such as general object alert, general collision avoidance, etc. Additional features will be apparent to artisans from the additional description following the example claims.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for moving objection detection in an image analysis system, the method comprising analyzing consecutive video frames from a single camera to extract box properties and exclude objects that are not of interest based upon the box properties, obtaining motion and structure data for boxes not excluded, sending the motion and structure data to a trained classifier, identifying moving object boxes by the trained classifier, and providing the moving object box identification to a vehicle system.

2. The method of claim 1, wherein the data sent to the classifier consists of the motion and structure data.

3. The method of claim 2, wherein the structure data includes box coordinates, normalized height, width and box area.

4. The method of claim 3, wherein the structure data includes a histogram of color space components.

5. The method of claim 4, wherein the motion data includes a histogram of direction data for each box of the boxes not excluded and a plurality of neighboring patches for each box.

6. The method of claim 1, wherein the motion data includes a histogram of direction data for each box of the boxes not excluded and a plurality of neighboring patches for each box.

7. The method of claim 1, wherein the box properties include bottom y and center x coordinate, normalized height, width and box area, and aspect ratio.

8. The method of claim 7, wherein boxes are excluded when the boxes are less than a predetermined size or adjacent a frame boundary.

9. The method of claim 1, wherein the motion data includes magnitude and direction of the motion for pixels in boxes and for neighboring patches and the classifier determined moving object boxes based upon differences in magnitude and direction of the motion for pixels.

10. The method of claim 9, wherein the data sent to the classifier consists of the motion and structure data.

11. A driver assistance system on a motor vehicle, the system including at least one camera providing video frames of scenes external to the vehicle, the video frames being provided to an image analysis processes, the processor executing the method of claim 1, the result of the analysis being used to trigger an alarm, a warning, a display or other indication to an operator of the vehicle, or to trigger a vehicle safety system in the form of automatic braking, speed control, or steering control, or to a vehicle autonomous driving control system.

12. A motor vehicle system comprising:
at least one camera providing video frames of scenes external to the vehicle;
an image analysis system, the image analysis system receiving consecutive video frames from said at least one camera, the image analysis system analyzing consecutive video frames from a single camera of said at least one camera to extract box properties and exclude objects that are not of interest based upon the box properties, obtaining motion and structure data for boxes not excluded, sending the motion and structure data to a trained classifier, identifying moving object boxes by the trained classifier, wherein the data sent to the classifier consists of the motion and structure data; and
a driving assistance or autonomous driving system that includes an object identification system and receives and responds to moving object boxes detected by the trained classifier.

13. The system of claim 12, wherein the motion data includes a histogram of direction data for each box of the boxes not excluded and a plurality of neighboring patches for each box.

14. The system of claim 12, wherein the box properties include bottom y and center x coordinate, normalized height, width and box area, and aspect ratio.

15. The system of claim 14, wherein boxes are excluded when the boxes are less than a predetermined size or adjacent a frame boundary.

16. The system of claim 12, wherein the motion data includes magnitude and direction of the motion for pixels in boxes and for neighboring patches and the classifier determined moving object boxes based upon differences in magnitude and direction of the motion for pixels.
